(19) United States
(12) Patent Application Publication
(10) Pub. No.: US 2026/0146690 A1
(43) Pub. Date: May 28, 2026

(54) SWIVEL-COMPRESSION FITTINGS AND SYSTEMS, KITS, AND METHODS INCORPORATING THE SAME

(71) Applicant: Titeflex Corporation, Springfield, MA (US)

(72) Inventors: Connor Welcome, Portland, TN (US); Jordan Strunk, Portland, TN (US); Paul Beshear, Springfield, TN (US)

(73) Assignee: Titeflex Corporation, Springfield, MA (US)

(21) Appl. No.: 19/334,143

(22) Filed: Sep. 19, 2025

Related U.S. Application Data
(60) Provisional application No. 63/725,389, filed on Nov. 26, 2024.

(51) Int. Cl. F16L 19/025; F25B 41/40

(52) U.S. Cl. CPC F16L 19/025; F25B 41/40

(57) ABSTRACT

An aspect of the invention provides a kit including: four fittings and a length of HVAC/R line set. Each of the four fittings include a fitting body and a nut. The fitting body defines: a swivel end and a second end. The swivel end includes: a sealing surface; a radially outer distal stop shoulder; a radially outer medial stop shoulder; and a radially outer neck having an outer diameter less than each of the radially outer distal stop shoulder and the radially outer medial stop shoulder. The nut includes a threaded region and a radially inner stop shoulder rotatably retained within the radially outer neck of the swivel end of the fitting body.

### CROSS-REFERENCE TO RELATED APPLICATION(S)

This application claims the benefit of priority under 35 U.S.C. § 119(e) to U.S. Provisional Patent Application Ser. No. 63/725,389, filed Nov. 26, 2024. The entire content of this application is hereby incorporated by reference herein.

### BACKGROUND OF THE INVENTION

Multilayer composite pipes are designed and used to convey liquids, primarily water, for applications such as in floor heating, radiator heating, and water supply.

### SUMMARY OF THE INVENTION

One aspect of the invention provides a fitting including: fitting body, a swivel nut, a ferrule, and a compression nut. The fitting body defines a swivel end including a sealing surface, a radially outer distal stop shoulder, a radially outer medial stop shoulder and a radially outer neck having an outer diameter less than each of the radially outer distal stop shoulder and the radially outer medial stop shoulder and a compression end including a nipple and a threaded region. The swivel nut includes: a threaded region and a radially inner stop shoulder rotatably retained within the radially outer neck of the swivel end of the fitting body. The ferrule is adapted and configured for placement radially over the nipple to engage a length of line set between the ferrule and nipple. The compression nut is adapted and configure to thread onto the threaded region of the compression end of the fitting body and compress the ferrule.

This aspect of the invention can have a variety of embodiments. The ferrule can be a split ferrule. The ferrule can include a plurality of annular ridges and valleys on a radially inner surface. One or more of the ferrule, the compression nut, and the compression end of the fitting body can define sloped surfaces adapted and configured to radially compress the ferrule as the compression nut advances medially.

The sealing surface can have a conical profile. The conical profile can have a 45° slope.

The fitting body can be formed of a metal. The metal can be brass.

The nipple can define a plurality of barbs on a radially outer surface. The nipple can include one or more O-rings on a radially outer surface.

Another aspect of the invention provides a kit including: four fittings and a length of HVAC/R line set. Each of the four fittings include a fitting body and a nut. The fitting body defines: a swivel end and a second end. The swivel end includes: a sealing surface; a radially outer distal stop shoulder; a radially outer medial stop shoulder; and a radially outer neck having an outer diameter less than each of the radially outer distal stop shoulder and the radially outer medial stop shoulder. The nut includes a threaded region and a radially inner stop shoulder rotatably retained within the radially outer neck of the swivel end of the fitting body.

This aspect of the invention can have a variety of embodiments. The kit can further include instructions for coupling the length of HVAC/R line set to an air handler and a compressor using the four fittings.

Another aspect of the invention provides a system including: a compressor; an evaporator coil; and a refrigerant line set coupled between the compressor and the evaporator coil to form a fluid circuit between the compressor and the evaporator coil. The refrigerant line set is coupled to the compressor and the evaporator coil by a set of four fittings. Each of the four fittings includes a fitting body and a second end. The fitting body defines a swivel end and a second end. The swivel end includes: a sealing surface; a radially outer distal stop shoulder; a radially outer medial stop shoulder; and a radially outer neck having an outer diameter less than each of the radially outer distal stop shoulder and the radially outer medial stop shoulder. The nut includes a threaded region and a radially inner stop shoulder rotatably retained within the radially outer neck of the swivel end of the fitting body.

This aspect of the invention can have a variety of embodiments. The system can further include a refrigerant contained within the fluid circuit. The refrigerant can be an A2L refrigerant.

Another aspect of the invention provides a method for installing a cut end of a tube over a fitting. The method includes: providing a tube having a cut end; advancing the compression nut of a fitting as described herein over the cut end of the tube; advancing the ferrule of the fitting over the cut end of the tube; advancing the cut end of the tube over the nipple of the fitting; rotating the compression nut relative to the fitting body of the fitting the such that the compression nut engages with the ferrule and compresses the ferrule and the ferrule engages and presses the cut end of the tube against the nipple, thereby forming a gas-tight seal between the cut end of the tube and the compression nut; advancing the swivel nut of the fitting onto a complementary threaded fitting; and rotating the swivel nut, thereby forming a gas-tight seal between the swivel nut and the complementary threaded fitting.

### BRIEF DESCRIPTION OF THE DRAWINGS

FIG. 1 is a diagrammatic illustration of a compression fitting, according to one or more embodiments.

FIG. 2 is flow diagram of a method for installing a tubing onto the compression fitting of FIG. 1, according to one or more embodiments.

FIG. 3 depicts a typical heating, ventilation, air-conditioning, and refrigeration (HVACR) system, according to one or more embodiments.

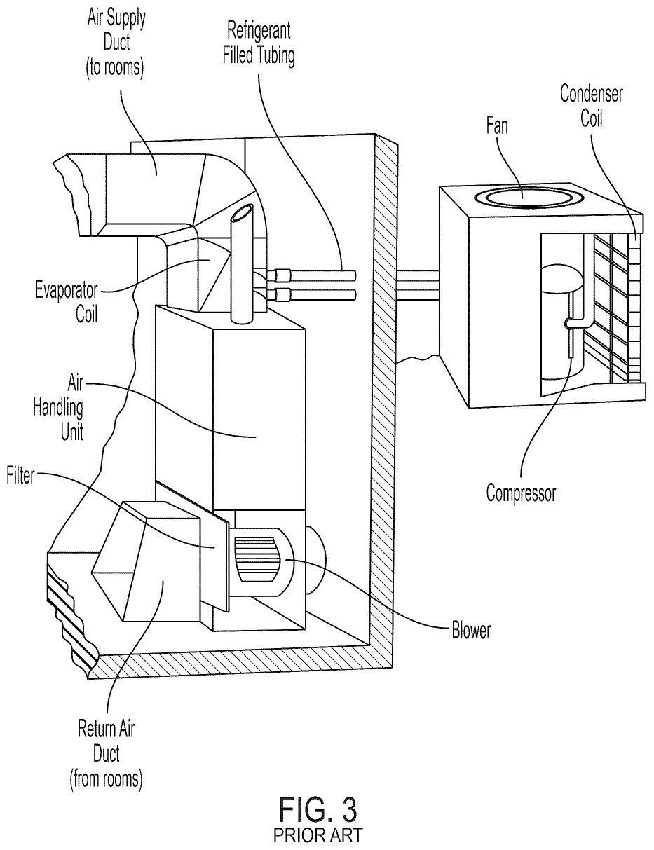

### DETAILED DESCRIPTIONS

Aspects of the invention provide fittings and systems, kits, and methods incorporating the same. The fittings described herein advantageously allow for a quicker and more secure fitting that a user can install or uninstall for use at any point after manufacture. Aspects of the invention provide a compression fitting that can utilize a flare swivel connection. For example, the fitting can be used for connecting refrigerant lines between components like compressors, condensers, evaporators, and/or the like in refrigerant systems. The fitting can allow a swivel nut to rotate freely, making installation easier and reducing the risk of damaging tubing. The flare swivel connection can provide a precision fit to ensure a gas-tight seal, e.g., with a male flare fitting.

In some embodiments, the compression fitting as described herein can include a nipple surrounded by a ferrule, e.g., with a split or gap along its length to allow the ferrule to compress and grip the tubing against the nipple when a compression nut is tightened around the ferrule. The nipple can include barbs and/or pockets for smooth and secure locking and unlocking. The barbs can hold retaining rings (e.g., O-rings, split bushing, etc.) for sealing and/or insulation against dissimilar metals. The barbs can be made from brass or stainless steel and can be integral with the fitting body.

The compression fitting can be mated with line set tubing such as a composite HVAC/R line-set tubing and/or a composite refrigeration line set. In some embodiments, the line set tubing can include an inner plastic tube, a first adhesive layer positioned about the inner plastic tube, an aluminum layer positioned about the first adhesive layer and coupled to the inner plastic tube via the first adhesive layer, a second adhesive layer positioned about the aluminum layer, and an outer plastic layer positioned about the aluminum layer coupled to the aluminum layer via the second adhesive layer. The inner plastic tube and/or outer plastic tube can be polyethylene (PE), polyethylene or raised temperature (PE-RT), polyethylene-fiberglass composite, polyamide (e.g., nylon), and the like. The aluminum layer can include an alloy selected from the group consisting of AL 3004-O, AL 3005-O, and AL 3555-O. In some cases, the aluminum layer can be butt-welded to itself. The composite refrigeration line set can further include a low-emissivity layer positioned about the outer plastic layer. The low-emissivity layer can include low-emissivity aluminum. The low-emissivity layer can include a metallized film. In some cases, the composite refrigeration line set tube can have a burst pressure in excess of 2100 pounds per square inch. The composite refrigeration line set can further include a reinforcement layer.

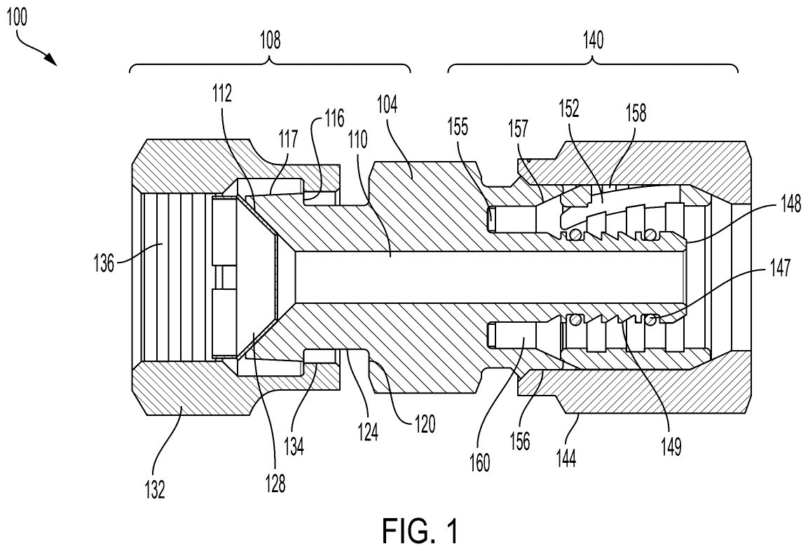

FIG. 1 is a diagrammatic illustration of a compression fitting 100, according to one or more embodiments. The fitting 100 includes a fitting body 104 defining a channel 110, a swivel end 108 and a compression end 140. The swivel end 108 can include a sealing surface 112, a radially outer distal stop shoulder 116, a radially outer medial stop shoulder 120, and a radially outer neck 124. In some implementations, the radially outer neck 124 can have an outer diameter less than the radially outer distal stop shoulder 116.

In some implementations, the sealing surface 112 can define an inward opening at, for example, 45° for and relative to the channel 110. The sealing surface 112 can also define a conical seat designed to match the angle of a male flare fitting to create a gas-tight seal. Fluids and/or gasses can pass through the channel 110 from the swivel end 108 to the compression end 140 and vice versa. In some cases, the sealing surface 112 can also define an area for a gasket 128.

In some implementations, the gasket 128 can include any seal configured to fill the area defined by the sealing surface 112 to form a gas-tight seal against the sealing surface 112 and for the channel 110 at the swivel end 108. In some cases, the gasket 128 can be metallic and/or plastic. The gasket 128 can have a complementary profile, e.g., a 45° conical shape with a central bore to allow fluids to flow through. The gasket 128 can be compressible to facilitate a gas-tight seal. Exemplary materials includes elastomers and soft metals such as copper. In some embodiments, the one or more surfaces of the gasket 128 can be coated with a liquid such as a sealant and/or lubricant. Such coating can both enhance sealing and retain the gasket 128, e.g., by adhesion or surface tension, against the flared sealing surface 112 prior to installation.

In some implementations, the fitting 100 can include a swivel nut 132 configured to couple to the fitting body 100 at the swivel end 108. The fitting 100 can be a female or a male swivel fitting (e.g., as defined by whether the swivel nut 132 has threads with radially inner or outer surface, respectively) and installed at the point of manufacture or in the field. The swivel nut 132 can rotate independently onto the fitting body 104, making it easier to tighten or loosen a connection of a flare end of a complementary threaded device (e.g., a flare fitting, a male flare fitting) onto the fitting body 104. In some cases, the swivel nut 132 can rotate to tighten or loosen the connection without twisting the connected tube and/or complementary threaded device or experiencing resistance to tightening.

In some implementations, the swivel nut 132 can include a threaded region 136. The threaded region 136 can include female threads or male threads. The threaded region 136 can be adapted and configured to be installed onto a complementary threaded device. In some cases, the threaded region 136 can include female threads, male threads, or other geometries for coupling, and can be sized to mate with common pipe sizes (e.g., ½″, ¾″, 1″, 1¼″, 1½″, 2″ Nominal Pipe Size). In some implementations, the swivel nut 132 can have wrench flats such as a hexagonal region on an outer surface of the swivel nut 132 such that the flats allows for tightening of the threaded region 136 into the complementary using a wrench, pliers, or other tool.

In some implementations, the swivel nut 132 can include a radially inner stop shoulder 134 that can engage with the radially outer distal stop shoulder 116 of the swivel end 108 of the fitting body 104 such that the swivel nut 132 is securely coupled to the fitting body 104 and resist distal movement as the swivel nut 132 is tightened. For example, the swivel nut 132 can be advanced medially (e.g., as facilitated by a tapered surface 117). The radially outer distal stop shoulder 116 can define a distally outer tapered surface 117 to allow for a radially inner stop shoulder 134 of the swivel nut 134 to slide towards the radially outer medial stop shoulder 120 and along the tapered surface 117 of the radially outer distal stop shoulder until it reaches the radially outer neck 124. The radially outer distal stop shoulder 116 can resist pullback of the radially inner stop shoulder 134 of the swivel nut 132. The radially outer medial stop shoulder 120 can act as a wall to prevent the radially inner stop shoulder 134 of the swivel nut 132 from advancing too far. The swivel nut 132 can be installed during manufacture through a variety of techniques including a mechanical (e.g., hydraulic) press and shrink-fitting techniques.

In some implementations, the compression end 140 can include a nipple 148 and a threaded region 156. In some cases, the threaded region 156 can be at the outer surface of the compression end 140, wherein the diameter of the compression end 140 and/or the threaded region 156 is greater than the diameter of the nipple 148. In some implementations, the compression end 140 can include a cavity 160 between the nipple 148 and the surface of the threaded region 156 such that a cut end of a tube can be inserted in the cavity 160.

In some implementations, the threaded region 156 can include female threads or male threads. The threaded region 156 can be adapted and configured to be installed with onto a complementary threaded device such as the compression nut 144. In some cases, the threaded region 136 can include female threads, male threads, or other geometries for coupling, and can be sized to mate with common pipe sizes (e.g., ½″, ¾″, 1″, 1¼″, 1½″, 2″ Nominal Pipe Size).

In some implementations, the nipple 148 can include annular grooves 149 (e.g., barbs, ridges, etc.). The annular grooves 149 can be along a radially outer surface of the nipple 148, to resist pullback of the cut end of the tube from the nipple 148. In some cases, the nipple 148 can have a tapered, beveled, or rounded end to facilitate medial insertion of the cut end of the tube into the cavity 160 and around the nipple 148. In some implementations, retaining rings 147 can be seated within the annular grooves 149 of the nipple 148 and engaged with complementary geometry of the cut end of the tube to distally retain the cut end of the tube and form a gas-tight seal. In some implementations, the retaining rings 147 can sit within gaps between the annular grooves 149 to prevent or resist pullback of the cut end of the tube. In some cases, the retaining ring 147 can be a split bushing, an O-ring, or the like. In some cases, the retaining rings 147 can deform or stretch to engage prior to seating in the annular grooves.

In some implementations, the fitting 100 can include a compression nut 144. The compression nut 144 can be advanced over a length of line set or a cut end of a tube, such that the compression nut 144 can be rotated to compress the cut end of the tube to secure it onto the compression end 140 and around the nipple 148. The fitting 100 can also include a ferrule 152. The ferrule 152 can be a ring or cap made of metal or plastic. In some cases, the ferrule 152 can be a split ferrule such that the ferrule 152 can expand or compress to allow for the easier installation of the cut end of the tube to the fitting body 104. In some implementations, the ferrule 152 can define a taper (e.g., 22.5°, 45°, etc.). In some cases, the fitting body 104 can include a tapered opening 157 that matches the taper of the ferrule 152 such that the ferrule 152 can be compressed between the cut end of the tube and the compression nut 144 and compress the cut end of the tube into the cavity 160. For instance, the tapered region of the ferrule 152 can slide along the surface of the tapered opening 157 to enable the ferrule 152 to easily compress the cut end of the tube into the cavity 160 and around the nipple 148.

In some implementations, the cavity 160 can define an area for a gasket 155 that can be inserted in the cavity 160 before insertion of the cut end of the tube and the compression nut 144.

In some implementations, the gasket 155 can include any seal configured to fill the area defined by the cavity 160 to form a gas-tight seal against the cut end of the tube and the compression end 140. In some cases, the gasket 155 can be metallic and/or plastic. The gasket 155 can be compressible to facilitate a gas-tight seal. Exemplary materials includes elastomers and soft metals such as copper. In some embodiments, the one or more surfaces of the gasket 155 can be coated with a liquid such as a sealant and/or lubricant. Such coating can both enhance sealing and retain the gasket 155, e.g., by adhesion or surface tension, prior to installation of the cut end of the tube.

In some implementations, the compression nut 144 can be adapted and configured to thread onto the threaded region 156 of the compression end 140 and compress the ferrule 152 within the cavity 160 and between the cut end of the tube and the threaded region 156. For instance, ferrule 152 can be advanced over the cut end of the tube after the advancement of the compression nut 144. The ferrule 152 can sit before or within the compression nut 144, but not distally beyond it. The ferrule 152 can be adapted and configured to engage the cut end of the tube onto the nipple 148 and compress the cut end of the tube into the cavity 160 by the rotation of the compression nut 144. The compression nut 144 can include a threaded region 158 configured to be threaded to the threaded region 156 of the compression end 140. The threaded region 156 of the compression end 140 and the threaded region 158 of the compression nut 144 can have male or female threads, but not both. For instance, a user can rotate the compression nut 140, via a wrench, in which the threaded region 158 of the compression nut 144 and the thread region 156 of the compression end 140 can be engaged and compress the compression nut 140 medially towards the fitting body 104. The compression can also grip and/or compress the ferrule 152 within the compression nut 144, which further compresses the cut end of the tube around the nipple 148, thereby forming a gas-tight seal between the nipple 148 and the cut end of the tube and between the cut end of the tube and an inner surface of the compression end 140 (or threaded region 156).

In some embodiments, the fitting 100 can be part of a kit (not shown in FIG. 1). For instance, the kit can include four fittings and instructions for coupling the length of HVAC/R line set to an air handler and a compressor using the four fittings. Each of the fittings in the kit can include a fitting body defining a swivel end comprising a sealing surface, a radially outer distal stop shoulder, a radially outer medial stop shoulder, and a radially outer neck having an outer diameter less than each of the radially outer distal stop shoulder and the radially outer medial stop shoulder. Each fitting can also include a second end and a nut comprising a threaded region a radially inner stop shoulder rotatably retained within the radially outer neck of the swivel end of the fitting body. The kit can also include a length of HVAC/R line set.

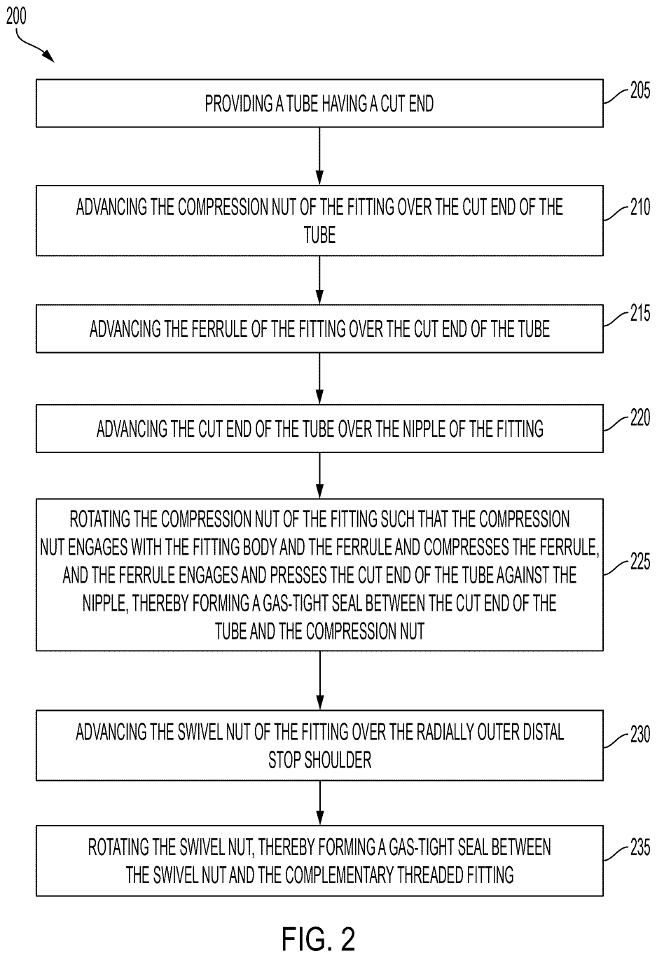

FIG. 2 is flow diagram of a method 200 for installing a tubing onto the compression fitting of FIG. 1, according to one or more embodiments. In some implementations, the method 200 can include a method for installing a cut end of a tube over a fitting.

At 205, the method 200 includes providing a tube having a cut end. The tube can include a composite HVAC/R line set tubing as sold under the PYTHON™ trademark from Titeflex Corporation of Springfield, Massachusetts and/or as described in U.S. Patent Application Publication Nos. US 2020/0400251, US 2021/0207744, US 2022/0032571, and US 2024/0133599. The line set can be cut to lengths in the field using tools such as a tubing cutter and reamed to remove burrs and swarf.

At 210, the method 200 includes advancing the compression nut of the fitting (e.g., fitting 100 of FIG. 1) over the cut end of the tube. The method 200 can be performed at the field or any place/location following the manufacture of the fitting.

At 215, the method 200 includes advancing the ferrule of the fitting over the cut end of the tube.

At 220, the method 200 includes advancing the cut end of the tube over the nipple of the fitting. In some embodiments, the fitting body can include a port that allows the user to visually confirm whether the cut end of the tube is sufficiently advanced. In other embodiments, the user can be instructed to mark the cut end of the tube a specified distance from the end and verify that the mark aligns with an end of the fitting body after advancement.

At 225, the method 200 includes rotating the compression nut relative to the nipple of the fitting the such that the compression nut engages with the ferrule and compresses the ferrule and the ferrule engages and presses the cut end of the tube against the nipple, thereby forming a gas-tight seal between the cut end of the tube and the compression nut.

At 230, the method 200 includes advancing the swivel nut of the fitting onto a complementary threaded fitting.

At 235, the method 200 includes rotating the swivel nut, thereby forming a gas-tight seal between the swivel nut and the complementary threaded fitting.

All combinations of the foregoing concepts and additional concepts discussed herewithin (provided such concepts are not mutually inconsistent) are contemplated as being part of the subject matter disclosed herein. The terminology explicitly employed herein that also can appear in any disclosure incorporated by reference should be accorded a meaning most consistent with the particular concepts disclosed herein.

The drawings are primarily for illustrative purposes, and are not intended to limit the scope of the subject matter described herein. The drawings are not necessarily to scale; in some instances, various aspects of the subject matter disclosed herein can be shown exaggerated or enlarged in the drawings to facilitate an understanding of different features. In the drawings, like reference characters generally refer to like features (e.g., functionally similar and/or structurally similar elements).

The entirety of this application (including the Cover Page, Title, Headings, Background, Summary, Brief Description of the Drawings, Detailed Description, Embodiments, Abstract, Figures, Appendices, and otherwise) shows, by way of illustration, various embodiments in which the embodiments can be practiced. The advantages and features of the application are of a representative sample of embodiments only, and are not exhaustive and/or exclusive. Rather, they are presented to assist in understanding and teach the embodiments, and are not representative of all embodiments. As such, certain aspects of the disclosure have not been discussed herein. That alternate embodiments cannot have been presented for a specific portion of the innovations or that further undescribed alternate embodiments can be available for a portion is not to be considered to exclude such alternate embodiments from the scope of the disclosure. It will be appreciated that many of those undescribed embodiments incorporate the same principles of the innovations and others are equivalent. Thus, it is to be understood that other embodiments can be utilized and functional, logical, operational, organizational, structural and/or topological modifications can be made without departing from the scope and/or spirit of the disclosure. As such, all examples and/or embodiments are deemed to be non-limiting throughout this disclosure.

Also, no inference should be drawn regarding those embodiments discussed herein relative to those not discussed herein other than it is as such for purposes of reducing space and repetition. For example, it is to be understood that the logical and/or topological structure of any combination of any program components (a component collection), other components and/or any present feature sets as described in the figures and/or throughout are not limited to a fixed operating order and/or arrangement, but rather, any disclosed order is exemplary and all equivalents, regardless of order, are contemplated by the disclosure.

In addition, the disclosure can include other innovations not presently described. Applicant reserves all rights in such innovations, including the right to embodiment such innovations, file additional applications, continuations, continuations-in-part, divisionals, and/or the like thereof. As such, it should be understood that advantages, embodiments, examples, functional, features, logical, operational, organizational, structural, topological, and/or other aspects of the disclosure are not to be considered limitations on the disclosure as defined by the embodiments or limitations on equivalents to the embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the embodiments, unless clearly indicated to the contrary, should be understood to mean “at least one.”

The phrase “and/or,” as used herein in the specification and in the embodiments, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements can optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the embodiments, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the embodiments, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the embodiments, shall have its ordinary meaning as used in the field of patent law.

As used herein in the specification and in the embodiments, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements can optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

Less specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from context, all numerical values provided herein are modified by the term about.

Ranges provided herein are understood to be shorthand for all of the values within the range. For example, a range of 1 to 50 is understood to include any number, combination of numbers, or sub-range from the group consisting 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 (as well as fractions thereof unless the context clearly dictates otherwise).

In the embodiments, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A fitting comprising:
a fitting body defining:
a swivel end comprising:
a sealing surface;
a radially outer distal stop shoulder;
a radially outer medial stop shoulder; and
a radially outer neck having an outer diameter less than each of the radially outer distal stop shoulder and the radially outer medial stop shoulder; and
a compression end comprising:
a nipple; and
a threaded region;
a swivel nut comprising:
a threaded region; and
a radially inner stop shoulder rotatably retained within the radially outer neck of the swivel end of the fitting body;
a ferrule adapted and configured for placement radially over the nipple to engage a length of line set between the ferrule and nipple; and
a compression nut adapted and configure to thread onto the threaded region of the compression end of the fitting body and compress the ferrule.

2. The fitting of claim 1, wherein the ferrule is a split ferrule.

3. The fitting of claim 1, wherein the ferrule comprises a plurality of annular ridges and valleys on a radially inner surface.

4. The fitting of claim 1, wherein one or more of the ferrule, the compression nut, and the compression end of the fitting body define sloped surfaces adapted and configured to radially compress the ferrule as the compression nut advances medially.

5. The fitting of claim 1, wherein the sealing surface has a conical profile.

6. The fitting of claim 5, wherein the conical profile has a 45° slope.

7. The fitting of claim 1, wherein the fitting body consists of a metal.

8. The fitting of claim 7, wherein the metal is brass.

9. The fitting of claim 1, wherein the nipple defines a plurality of barbs on a radially outer surface.

10. The fitting of claim 1, wherein the nipple comprises one or more O-rings on a radially outer surface.

11. A kit comprising:
four fittings, each of the four fittings comprising:
a fitting body defining:
a swivel end comprising:
a sealing surface;
a radially outer distal stop shoulder;
a radially outer medial stop shoulder; and
a radially outer neck having an outer diameter less than each of the radially outer distal stop shoulder and the radially outer medial stop shoulder; and
a second end; and
a nut comprising:
a threaded region; and
a radially inner stop shoulder rotatably retained within the radially outer neck of the swivel end of the fitting body; and
a length of HVAC/R line set.

12. The kit of claim 11, further comprising:
instructions for coupling the length of HVAC/R line set to an air handler and a compressor using the four fittings.

13. A system comprising:
a compressor;
an evaporator coil; and
a refrigerant line set coupled between the compressor and the evaporator coil to form a fluid circuit between the compressor and the evaporator coil;
wherein the refrigerant line set is coupled to the compressor and the evaporator coil by a set of four fittings, each of the four fittings comprising:
a fitting body defining:
a swivel end comprising:
a sealing surface;
a radially outer distal stop shoulder;
a radially outer medial stop shoulder; and
a radially outer neck having an outer diameter less than each of the radially outer distal stop shoulder and the radially outer medial stop shoulder; and
a second end; and
a nut comprising:
a threaded region; and
a radially inner stop shoulder rotatably retained within the radially outer neck of the swivel end of the fitting body.

14. The system of claim 13, further comprising:
a refrigerant contained within the fluid circuit.

15. The system of claim 14, wherein the refrigerant is an A2L refrigerant.

16. A method for installing a cut end of a tube over a fitting, the method comprising:
providing a tube having a cut end;
advancing the compression nut of the fitting of claim 1 over the cut end of the tube;
advancing the ferrule of the fitting over the cut end of the tube;
advancing the cut end of the tube over the nipple of the fitting;
rotating the compression nut relative to the fitting body such that:
the compression nut:
engages with the ferrule; and
compresses the ferrule; and
the ferrule engages and presses the cut end of the tube against the nipple, thereby forming a gas-tight seal between the cut end of the tube and the compression nut;
advancing the swivel nut of the fitting onto a complementary threaded fitting; and
rotating the swivel nut, thereby forming a gas-tight seal between the swivel nut and the complementary threaded fitting.
